(19) United States
(12) Patent Application Publication
(10) Pub. No.: US 2009/0016624 A1
(43) Pub. Date: Jan. 15, 2009

(54) Method of graphics and image data compression

(76) Inventors: Chih-Ta Star Sung, Glonn (DE); Bey-Yun Kuo, Banciao City (TW)

Correspondence Address: Chih-Ta Star Sung, Rm. 308, Bld. 52, No. 195, Sec. 4, Chung Hsin Rd., Juhdong, 310, TW

(21) Appl. No.: 11/827,432

(22) Filed: Jul. 12, 2007

(51) Int. Cl. G06K 9/36

(52) U.S. Cl. 382/238

(57) ABSTRACT

This image compression applies a mixture compression algorithm to code the differential value of the adjacent pixels. The first table saves a predetermined number of the most frequent patterns and the second table saves another predetermined number of the most frequent patterns and both apply fixed length code to represent the matched pattern of current pixel.

### BACKGROUND OF THE INVENTION

1. Field of Invention

The present invention relates to digital image and graphics data compression, and, more specifically to an efficient image compression method that results in a high image quality in natural and animated images.

2. Description of Related Art

Compression has key benefits in cost reduction of storage device and speedup in accessing the compressed data. Most popular still image compression standards including JPEG, JPEG2000 are lossy algorithms which cause data difference between the decompressed and original image during the procedure of image compression. The data loss caused by lossy compression algorithm degrades the image quality which might not be acceptable in some applications.

There are very few lossless image compression algorithms of image data reduction. One of most commonly adopted approach is taking differential value between adjacent pixels and applying the so called “entropy coding” or “Variable Length Coding” method which uses the shortest code to represent the most frequent happened pattern.

Lossy compression algorithms can achieve higher compression rate, for example, between 10 to 20 times, at the cost of sacrificing the image quality. Sharp image quality can be achieved by the lossless compression algorithm but the compression rate is most likely lower than that of the popular lossy algorithms like JPEG or JPEG2000.

Most compression algorithms are conceptually good for natural images and might not be good in animated image. Very few compression algorithms can reach good compression ratio of animated image.

The method of this invention of image and graphics data compression is to achieve a reasonable high compression ratio compared to prior art lossless compression algorithms without sacrificing much the image quality in both natural and animated images.

### SUMMARY OF THE INVENTION

The present invention overcomes the drawback of the popular compression algorithms which introduce high degree of quality degradation. The present invention reduces the computing times compared to its counterparts in the image compression and decompression and reaches higher compression ratio for both natural and animated images.

The present invention of this high quality natural and graphics image compression applies a prediction mechanism to decide which of the selected coding modes is applied to reduce the data rate of image and graphics data.

For gaining higher image quality, the present invention of this natural and graphics image compression decides which of the following four coding algorithms is selected to reduce the data rate of the differential value between the adjacent pixels of a group of images.
1. Predicting divider value of each DPCM value and coding the Quotient and Remainder according the divider value.
2. Coding the DPCM value by assigning a code which is saved in the first table which maps for example the 16 most frequent happen patterns within an image in previous pixels.
3. Coding the DPCM value by assigning a code which is saved in the second table which maps for example the 4 most frequent happen patterns within an image in previous pixels which might include 2 from upper segment and another 2 from left segments.
4. Coding the DPCM value by assigning a code of “Repeat” and followed by a code of “Time of Repeat”.

According to one embodiment of the present invention, the first table stores for example, approximately 16 patterns which are most frequent values in previous pixels within an image.

According to one embodiment of the present invention, the second table stores for example, approximately 4 patterns which are most frequent happened values which might be comprised of the 2 most frequent happened patterns in upper segment and 2 most frequent happened patterns in previous pixels within an image frame.

According to one embodiment of the present invention, multiple counters are used to calculate the time of “Pattern Repeat” and if the time is larger than a threshold, this mode is selected to be the coding method of representing the present image.

According to another embodiment of the present invention, the “Repeat” pattern can be a pattern being coded by predicting the divider and coding the Quotient and Remainder, or one of the top 16 patterns or one of the top 4 patterns.

It is to be understood that both the foregoing general description and the following detailed description are by examples, and are intended to provide further explanation of the invention as claimed.

### BRIEF DESCRIPTION OF THE DRAWINGS

FIG. 1 depicts a prior art, the JPEG still image compression procedure.

FIG. 2 depicts another prior art of image compression: differential value of adjacent pixels with variable length coding.

FIG. 3 illustrates the procedure of this invention of high quality image compression with multiple paths of compressions including at least two look up table means of pixel coding by referring to the most frequent patterns.

FIG. 4 depicts the procedure of a conceptual most frequent pattern coding and examples.

FIG. 5 depicts the concept of the targeted pixel can be coded by referring to the most frequent patterns of upper or left segment.

FIG. 6 illustrates the concept of coding pixel with repetitive pattern.

### DESCRIPTION OF THE PREFERRED EMBODIMENTS

Due to sharp quality and good immunity to the noise, and convenient in storage, the digital image has prevailingly become popular in mass applications like digital camera, digital camcorder, digital photo albums, scanner/printer/fax, image archiving and storage . . . etc.

For saving the requirement of density of storage device and time of transmission, image compression technology has been deployed to reduce the data rate of the digital image. In the past decades, many image compression algorithms have been applied to image applications. Some are lossy and very few are lossless. Lossy means the recovered or decompressed image from a compressed image will have data loss compared to the original image. ITU and ISO have developed and defined some image and video compression algorithms including JPEG, an still image compression standard and MPEG, the video compression standard. The JPEG image has widely applications with the cost of data loss compared to the original image.

JPEG image compression as shown in FIG. 1 includes some procedures in compression. The color space conversion 10 is to separate the luminance (brightness) from chrominance (color) and to take advantage of human being's vision less sensitive to chrominance than to luminance and the can reduce more chrominance element without being noticed. An image 14 is partitioned into many units of so named “Block” of 8×8 pixels to run the JPEG compression.

A color space conversion 10 mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr 11, 12, 13 by the following procedures:

Step 1: Discrete Cosine Transform (DCT)

Step 2: Quantization

Step 3: Zig-Zag scanning

Step 4: Run-Length pair packing and

Step 5: Variable length coding (VLC).

DCT 15 converts the time domain pixel values into frequency domain. After transform, the DCT “Coefficients” with a total of 64 sub-bands of frequency represent the block image data, no long represent single pixel. The 8×8 DCT coefficients form the 2-dimension array with lower frequency accumulated in the left top corner, the farer away from the left top, the higher frequency will be. Further on, the closer to the left top, the more DC frequency which dominates the more information. The more right bottom coefficient represents the higher frequency which less important in dominance of the information. Like filtering, quantization 16 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantization step, the higher the compression and the more distortion the image will be.

After quantization, most DCT coefficient in the right bottom direction will be rounded to “0s” and only a few in the left top corner are still left non-zero which allows another step of said “Zig-Zag” scanning and Run-Length packing 17 which starts left top DC coefficient and following the zig-zag direction of scanning higher frequency coefficients. The Run-Length pair means the number of “Runs of continuous 0s”, and value of the following non-zero coefficient.

The Run-Length pair is sent to the so called “Variable Length Coding” 18 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression. JPEG is a lossy compression algorithm, the JPEG picture with less than 10× compression rate has sharp image quality, 20× compression will have more or less noticeable quality degradation.

The JPEG compression procedures are reversible, which means the following the backward procedures, one can decompresses and recovers the JPEG image back to raw and uncompressed YUV (or further on RGB) pixels. The main disadvantage of JPEG compression algorithm is the input data are sub-sampled and the compression algorithm itself is a lossy algorithm caused by quantization step which might not be acceptable in some applications.

Very few lossless image compression algorithms have been developed due to the following two factors:
The standard JPEG Image with 10× compression rate has still acceptable good image quality in most applications.
It is tough to achieve high compression rate of the lossless compression.

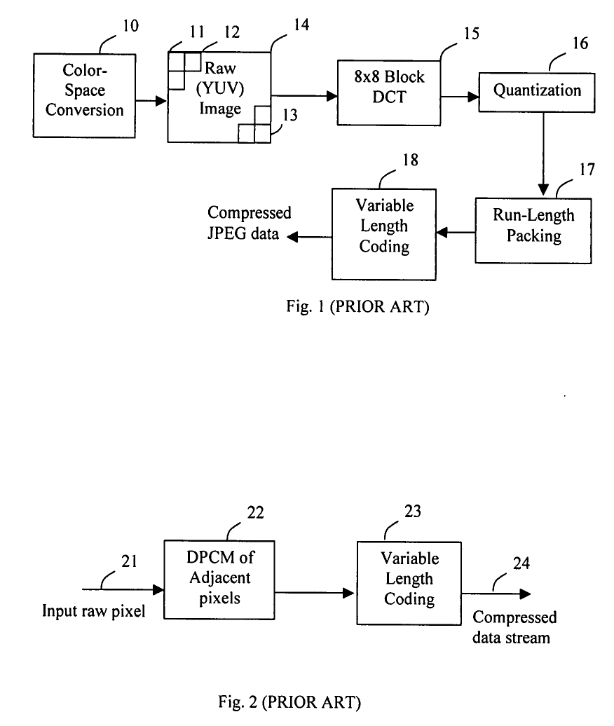

A well know prior art of the lossless image compression method is shown in FIG. 2 which calculates the differential value 22 of the input adjacent pixels 21 and runs the variable length coding 23, the VLC coding. A VLC coding uses the shortest code to represent the most frequent happen pattern, and longer code to represent the less frequent happen pattern. The disadvantage of the prior art in FIG. 2 is that it can not reach higher compression rate.

This invention of the image compression overcomes disadvantages of both lossy compression algorithm like JPEG and another prior art of VLC coding of the differential values of adjacent pixel in quality and compression rate issues. This invention applies a mixture of new lossless compression algorithms and another new lossy compression algorithm to reach high image quality and reasonable high compression rate.

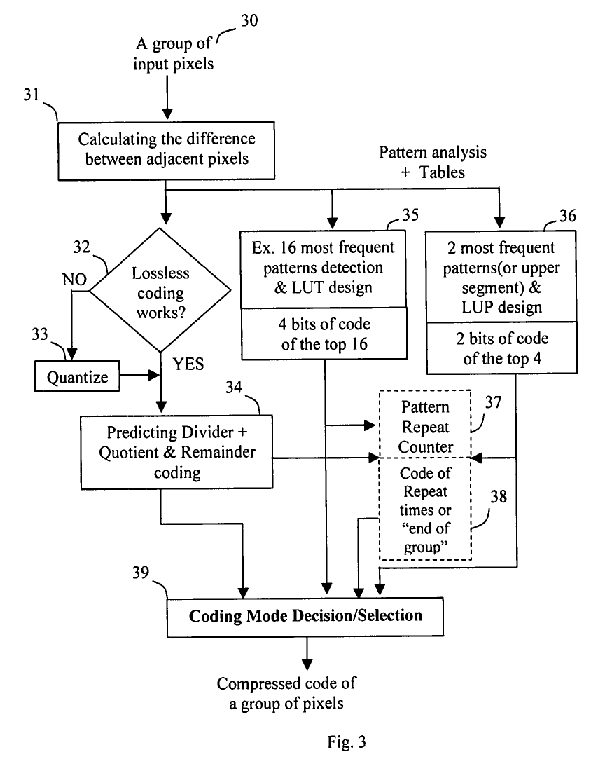

As shown in FIG. 3, a group of input pixels 30 will be calculated the differential values 31 between adjacent pixels and be examined to see whether the complexity of pixels allows this group of pixels to be compressed by a lossless compression algorithm 32 under the predetermined bit rate. The selected VLC coding method in this invention is a lossless compression which codes the value of Quotient and Remainder 33 with predictive divider, for simplification in hardware implementation, is always shifted to be the power of “2” and used implicit way to code without coding the divider into the bit stream. For instant, a divider can always be predefined to be the average of current differential value of adjacent pixels and previous average divider as show in the equation below:

Div_{—}_{ₙ}=(Div_{—}_{ₙ₋₁}+Diff_{—}_{ₙ})/2

This predictive divider has 50% weighted factor of the latest pixel information, said the Diff_{—}_{ₙ} and another 50% from accumulated dividers.
Should a lossless compression under a predetermined bit rate is not possible, a lossy compression of quantization step 33 will play the role of compression followed by the VLC coding as above paragraph.

Another mechanism of reaching higher compression ratio of digital image of this invention is applying a mapping method. A predetermined size of a table, a temporary buffer is used to save the most frequent show-up patterns, for example, 16 patterns. Should the current pixel happens to be the same of one of the patterns saved in the table, the corresponding code can be used to represent the differential value of that pixel. For coding efficiency, this invention applies two separate look up tables with each for example having top 16 most frequent patterns 35 and 4 most frequent patterns 36. The 16 most frequent patterns require 4 bits to represent, while the 4 most frequent patterns need 2 bits to represent. Each input pixel will be sent this these two mechanisms for calculating the frequency of show-up. The input pixels will also be conducted to be counted how many times the pattern is continuously repeated 37. The counter bit number is predetermined, for instant, a 3 bits to represent up to 7 times of continuously show up pattern. Another code is reserved to represent “End of Group” 38 means no longer “Non-zero” differential value of adjacent pixels to the end of a group.

For gaining higher coding efficiency, the first table saves up to 16 the most frequent patterns which can use a fixed 4 bits to represent each pattern, while the second table saves up to 4 the most frequent patterns which can use a fixed 2 bits to represent each pattern.

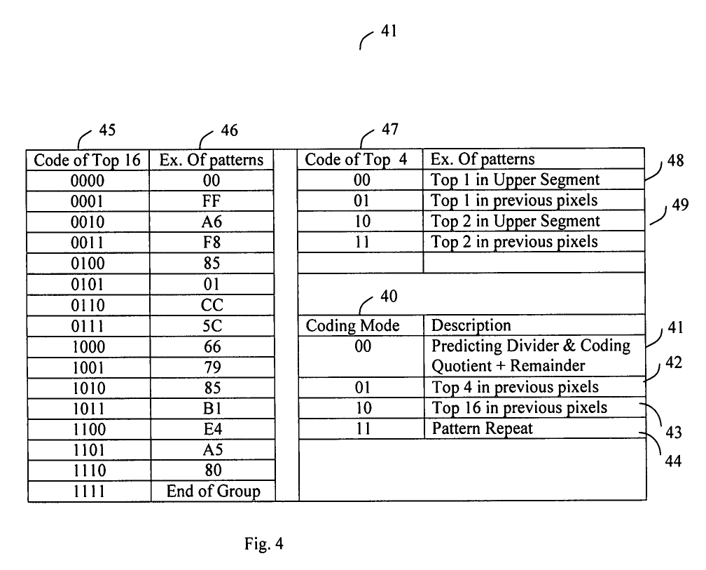

FIG. 4 shows a table listing the examples of the most frequent 16 patterns and most frequent 4 patterns as well as the time of repetitiveness. For example, the first column depicts the 4 bits 45 of code represent the 16 most frequent patterns (for instant, 00, FF, . . . 46). Another column on the right side of 2 bits 47 depicts another most frequent 4 patterns 47 which might include 2 most frequent patterns from the same location of upper line 48 and another 2 most frequent patterns from left/previous group 49. A 2 bits code 40 is reserved for code mode indication: one of the new four compression modes: Predicting divider+Quotient/Remainder coding 41, Most frequent 16 patterns patching 42, Most frequent 4 patterns patching 43 and Pattern repeat 44. If “Pattern Repeat” is coded, the code followed represents the times of repetitiveness.

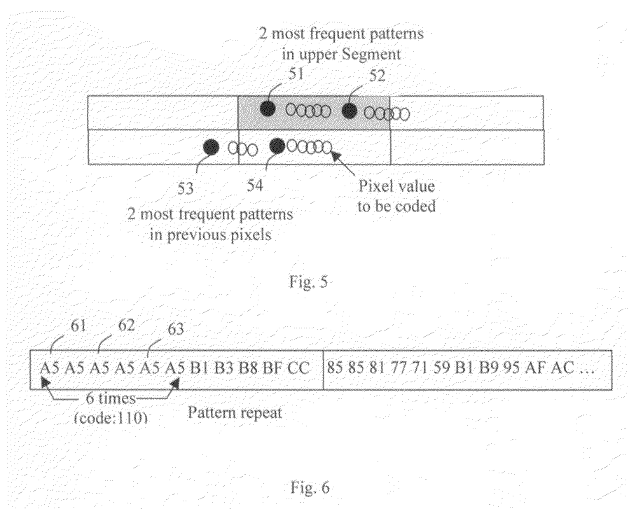

FIG. 5 illustrates the concept of coding a pixel by referring to upper line and left segments. For example, the two most frequent patterns in the same segment of upper line 51, 52 are saved into the second table which saves the most frequent patterns. And the two most frequent patterns of previous pixels 53, 54 are saved into the second table. The DPCM value of the current pixel will be compared to the values of the second table and if a match happens, the corresponding code of either most frequent patterns of upper line or previous patterns will represent the current pixel.

FIG. 6 shows an example of “Pattern Repeat” and the corresponding code. As a pattern of “A5” shows after a pattern of B1, and followed by another 5 times of “A5” 61, 62, 63. A code mode with code of “11” is assigned to represent “Pattern Repeat” mode, following by Value of “A5” and a code of “110” representing a total of six times of “Repeat”.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of reducing the bit rate of a digital image, comprising:
partitioning a frame of pixels into a predetermined amount of groups of pixels with each group having a predetermined amount of pixel components and compressing the differential values between the adjacent pixels within an image frame group by group with the following procedure:
1^{st} method: predicting divider value of each DPCM value and coding the Quotient and Remainder according the divider value.
2^{nd} method: coding the DPCM value by assigning a code which is saved in the first table which maps no less than 8 most frequent happen patterns within an image in previous pixels.
3^{rd} method: coding the DPCM value by assigning a code which is saved in the second table which maps no less than 2 most frequent happen patterns within an image in previous pixels.
4^{th} method: coding the DPCM value by assigning a code of “Repeat” and followed by a code of “Time of Repeat”; and
selecting one of the above codes with shortest bit length to represent the corresponding group of pixels.

2. The method of claim 1, wherein the first algorithm, the selected lossless compression method codes only the quotient and remainder of each pixel component by dividing the differential value of current pixel component by the predicted previous divider.

3. The method of claim 2, wherein the predictive present divider value is an average of the previous accumulative divider and the DPCM value of current pixel component.

4. The method of claim 1, wherein the second method, the first counter calculates the times of pattern and records into the first table listing no less than eight pixels which also updates the order of most frequent show up pattern of the differential value.

5. The method of claim 1, wherein the third method, the second counter calculates the times of pattern and records into the second table listing no less than four pixels which also updates the order of most frequent show up pattern of the differential value.

6. The method of claim 1, wherein the first method, the selected lossy algorithm quantizes the differential value by mapping the differential value to a predetermined value of that corresponding interval.

7. The method of claim 1, wherein the first table and the second table both save the most frequent patterns, have different amount of patterns with one having the first fixed length of bits and another having the second fixed length of bits to represent the most frequent patterns.

8. The method of claim 1, wherein the first table saves up to fifteen the most frequent patterns and the second table saves up to seven the most frequent patterns.

9. A method of compressing digital image, comprising:
Partitioning a frame of pixels into a predetermined amount of segments of pixels with each segment having a predetermined amount of pixel components and calculating the differential value between adjacent pixels within a segment;
Saving at least one of the most frequent patterns of each segments of the upper line of pixels into the first temporary buffer;
Saving at least one of the most frequent patterns of each segments of previous pixel of the current line of pixels into the second temporary buffer; and
Comparing the current pixel differential value to the most frequent patterns saved in upper line and current line by examining the first and the second temporary buffer, should a match happens, assigning the code of the most frequent patterns to represent the current pixel.

10. The method of claim 9, wherein the first temporary buffer can store up to two most frequent patterns, while the second temporary buffer stores two most frequent patterns.

11. The method of claim 9, wherein the a fixed two bits code is assigned to represent four most frequent patterns with one or two from upper line and another one or two from the left or previous segment.

12. A method of compressing digital image, comprising:
partitioning a frame of pixels into a predetermined amount of segments of pixels with each segment having a predetermined amount of pixel components and calculating the differential value between adjacent pixels within a segment;
applying a corresponding coding method to represent the patterns which are not “all 0s” till the end of the segment; and
applying a code of “end of segment” to represent patterns of “all 0s” till the end of a segment.

13. The method of claim 12, wherein method of coding the “not all 0s” pattern is a mixture of lossless and lossy algorithm.

14. The method of claim 12, wherein when the accumulative complexity is less than the first threshold, a predetermined first quantization step is applied to the corresponding group for converging differential values, when the accumulative complexity is less than the second threshold, a predetermined second quantization step is applied to the corresponding group for converging differential values, . . . etc.
